(19) United States
(12) Patent Application Publication
(10) Pub. No.: US 2024/0102324 A1
(43) Pub. Date: Mar. 28, 2024

(54) A REDUNDANCY SYSTEM FOR A VEHICLE DOOR LOCK, A VEHICLE COMPRISING THE REDUNDANCY SYSTEM, AND A METHOD FOR OPERATING A REDUNDANCY SYSTEM

(71) Applicants: Ningbo Geely Automobile Research & Development Co., Ltd., Ningbo (CN); Zhejiang Geely Holding Group Co., Ltd., Zhejiang (CN)

(72) Inventor: Luca MAREGA, Lilla Edet (SE)

(21) Appl. No.: 18/523,663

(22) Filed: Nov. 29, 2023

Related U.S. Application Data
(63) Continuation of application No. PCT/CN2022/098115, filed on Jun. 10, 2022.

(30) Foreign Application Priority Data
Jun. 30, 2021 (EP) 21182724.1

(51) Int. Cl. E05B 81/06; E05B 81/14; E05B 85/04

(52) U.S. Cl. CPC E05B 81/06; E05B 81/14; E05B 85/04

(57) ABSTRACT

A redundancy system for a vehicle door lock. The redundancy system includes a body attached to a vehicle body structure of a vehicle and a striker releasably connected to the body. An outer end of the striker is configured for interacting with a locking unit of a vehicle door for releasably connecting the vehicle door to the vehicle body structure. The body includes a passage for receiving an inner end of the striker. The inner end of the striker is extending through a structural part of the vehicle body structure from an outer side of the structural part to an inner side of the structural part when connected to the body.

### RELATED APPLICATION DATA

This application is a continuation of International Patent Application No. PCT/CN2022/098115, filed Jun. 10, 2022, which claims the benefit of European Patent Application No. 21182724.1, filed Jun. 30, 2021, the disclosures of which are incorporated herein by reference in their entireties.

### TECHNICAL FIELD

The present disclosure relates to a redundancy system for a vehicle door lock. The redundancy system comprises a body attached to a vehicle body structure of a vehicle and a striker connected to the body. An outer end of the striker is configured for interacting with a locking unit of a vehicle door for releasably connecting the vehicle door to the vehicle body structure. The disclosure further relates to a vehicle comprising the redundancy system, and a method for operating a redundancy system.

### BACKGROUND

Modern vehicle door locks are commonly remotely controlled and operated with actuators for locking and unlocking functions. In certain situations, vehicle doors may not be possible to open, such as for example in case of vehicle power outage in workshop operations, vehicle battery drainage, or deformation of vehicle components in a vehicle impact event. A redundancy system for enabling opening of a vehicle door in such situations is therefore highly desirable.

Within the development of new vehicle door systems, especially in autonomous drive contexts, the vehicle doors are becoming slimmer and lighter. Conventional door sub-systems are optimized in size and weight and improved in terms of efficiency, and additional functionalities trigger hardware that is more complex. The latch/locking system is recently arranged with electrical redundancy systems, where latches connected to handles via electrical harnesses, and often the electrical redundancy systems are supported by mechanical redundancy systems where the latches are connected to handles via wire systems. However, these mechanical redundancy systems are complex in construction. There is thus a need for an improved mechanical redundancy system that is easy to operate as well as simple and reliable in construction for an efficient opening of vehicle doors.

### SUMMARY

An object of the present disclosure is to provide a redundancy system for a vehicle door lock, a vehicle comprising the redundancy system, and a method for operating a redundancy system, where the previously mentioned problems are avoided. This object is at least partly achieved by the features of the independent claims. The dependent claims contain further developments of the redundancy system for a vehicle door lock and the method for operating a redundancy system.

The disclosure concerns a redundancy system for a vehicle door lock. The redundancy system comprises a body attached to a vehicle body structure of a vehicle and a striker releasably connected to the body. An outer end of the striker is configured for interacting with a locking unit of a vehicle door for releasably connecting the vehicle door to the vehicle body structure. The body comprises a passage for receiving an inner end of the striker. The inner end of the striker is extending through a structural part of the vehicle body structure from an outer side of the structural part to an inner side of the structural part when connected to the body.

Advantages with these features are that through the releasable connection of the striker to the body, the striker can be removed from the body in an emergency state where the doors of the vehicle are not possible to open, such as for example in case of vehicle power outage in workshop operations, vehicle battery drainage, or deformation of vehicle components in a vehicle impact event. Through the releasable connection, the opening of the vehicle door is enabled in such situations, since the striker when in engagement with the locking unit of the vehicle door and released from the body can be removed from the body through action from the vehicle door. The striker will thus follow the vehicle door when opened, since the striker is released from the body. The solution is providing an efficient and improved mechanical redundancy system that is easy to operate as well as simple and reliable in construction for an efficient opening of vehicle doors in an emergency state.

In one embodiment, the body is attached to the outer side of the structural part. With this configuration, the body is simple to attach to the structural part, and the positioning of the body is further allowing easy interaction between the striker and the locking unit.

In one embodiment, the outer end is arranged on the outer side of the structural part when connected to the body. The outer end of the striker is engaging the locking unit for locking the vehicle door to the vehicle body structure in a closed door position.

In one embodiment, the structural part of the vehicle body structure comprises an opening. The inner end is extending through the opening when connected to the body, at least partly positioning the inner end on the inner side of the structural part. The opening is allowing the inner end of the striker to extend into the inner side for a compact and efficient design of the redundancy system.

In one embodiment, the redundancy system further comprises a connection member configured for being releasably connected to a connection part of the inner end. The connection member is engaging the striker for holding the striker in position to the body when the vehicle doors are closed and opened during normal operation. In the emergency state, the connection member can be released from the striker, allowing the striker to be removed from the body.

According to an embodiment, the body comprises an inner part arranged on the inner side of the structural part. The inner part comprises a receiving opening, and the connection member is extending through the receiving opening and into the connection part when the connection member is connected to the connection part. This is allowing a secure connection between the striker and the body for preventing unwanted release of the striker from the body.

According to an embodiment, the connection member is further connected to a releasing mechanism. The releasing mechanism is upon activation configured for releasing the connection member from the connection part. The releasing mechanism is thus used for removing the connection member from the striker in an emergency state. When the connection member is removed from the striker, the striker can be pulled out from the body through action from the vehicle door when being opened for enabling a door opening operation in the emergency state.

According to an embodiment, the releasing mechanism is connected to the connection member via a wire, where the wire is configured for releasing the connection member from the connection part upon activation of the releasing mechanism. The wire is providing a simple and reliable mechanical solution for removing the connection member from the striker.

According to an embodiment, the releasing mechanism is arranged as a lever connected to the vehicle body structure. The lever is used for a simple operation of the redundancy system, and by operating the lever; the connection member is removed from the striker in a simple and efficient manner through interaction by the wire. When the lever is operated, the wire is pulled, and in turn, the wire is pulling the connection member away from the striker.

According to an embodiment, the connection member is arranged on the inner side of the structural part. The connection part of the striker is arranged on the inner side of the structural part when connected to the body, and the arrangement of the connection member on the inner side is enabling connection between the connection member and the connection part of the striker in a simple and reliable manner.

According to an embodiment, the connection member is configured for being releasably connected to the connection part through snap-action. The snap-action is used for providing a secure connection of the connection member to the connection part of the striker, preventing accidental or unwanted release of the striker from the body.

According to an embodiment, the connection member is in a normal operating state connected to the connection part for connecting the striker to the body. Upon activation in an emergency state, the connection member is configured for being released from the connection part, and when the connection member is released from the connection part the striker can be removed from the body, for a simple operation of the redundancy system.

In one embodiment, the structural part of the vehicle body structure is a wall section arranged in connection to an A-pillar, B-pillar, C-pillar, or a D-pillar, of the vehicle body structure B.

The disclosure further concerns a vehicle V comprising the redundancy system above.

The disclosure further concerns a method for operating a redundancy system for a vehicle door lock. The redundancy system comprises a body attached to a vehicle body structure of a vehicle and a striker releasably connected to the body. An outer end of the striker is configured for interacting with a locking unit of a vehicle door for releasably connecting the vehicle door to the vehicle body structure. The body comprises a passage for receiving an inner end of the striker, where the inner end of the striker is extending through a structural part of the vehicle body structure from an outer side of the structural part to an inner side of the structural part when connected to the body. A connection member is releasably connected to a connection part of the inner end in a normal operating state. The method comprises the steps: releasing the connection member from the connection part upon activation in an emergency state and removing the striker from the body when the connection member is released from the connection part.

Advantages with these features are that by releasing the connection member from the connection part of the striker, the striker can be removed from the body in the emergency state where the doors of the vehicle are not possible to open, such as for example in case of vehicle power outage in workshop operations, vehicle battery drainage, or deformation of vehicle components in a vehicle impact event. Through the releasable connection, the opening of the vehicle door is enabled in such situations, since the striker when in engagement with the locking unit of the vehicle door and released from the body can be removed from the body through action from the vehicle door. The solution is providing an efficient and improved mechanical redundancy system that is easy to operate as well as simple and reliable in construction for an efficient opening of vehicle doors in an emergency state.

In one embodiment, the connection member is connected to a releasing mechanism via a wire. The method comprises the step: releasing the connection member from the connection part through action from the wire, upon activation of the releasing mechanism in the emergency state. The wire is configured for releasing the connection member from the connection part upon activation of the releasing mechanism. The releasing mechanism and the wire is providing a simple and reliable mechanical solution for removing the connection member from the striker.

### BRIEF DESCRIPTION OF THE DRAWINGS

The disclosure will be described in detail in the following, with reference to the attached drawings, in which

FIG. 1 shows schematically, in a perspective view, a section of a vehicle with a redundancy system for a vehicle door lock according to the disclosure,

FIGS. 2A-2B show schematically, in perspective views, the attachment of a body of the redundancy system to a body structure of the vehicle according to the disclosure,

FIGS. 2C-2D show schematically, in perspective views, the connection of a striker to the body of the redundancy system according to the disclosure,

FIGS. 2E-2F show schematically, in perspective views, the connection of a connection member of the redundancy system a to a connection part of the striker according to the disclosure,

FIGS. 3A-3D show schematically, in cross-sectional and perspective views, the interaction between the striker and a locking unit of a vehicle door, and the operation of the redundancy system in an emergency state,

FIGS. 4A-4C show schematically, in views from above, positioning of the striker to the vehicle body structure of the vehicle in different embodiments.

### DETAILED DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

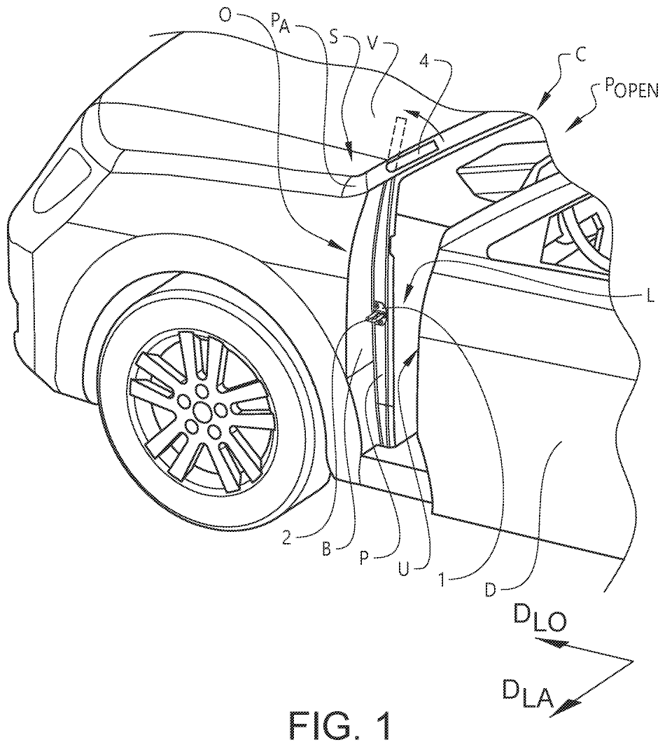

FIG. 1 schematically shows a vehicle V with a vehicle door D, where the vehicle door is movably arranged in relation to a vehicle body structure B of the vehicle V. The vehicle door D can be displaced between a closed door position P_{CLOSED} and open door positions P_{OPEN} in any conventional manner. The vehicle V comprises a redundancy system S for a vehicle door lock L.

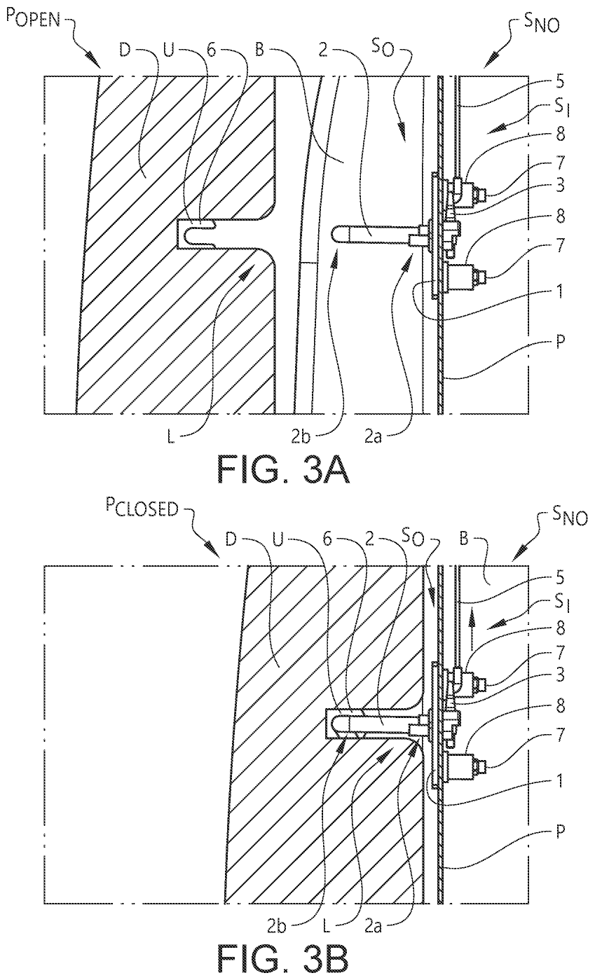

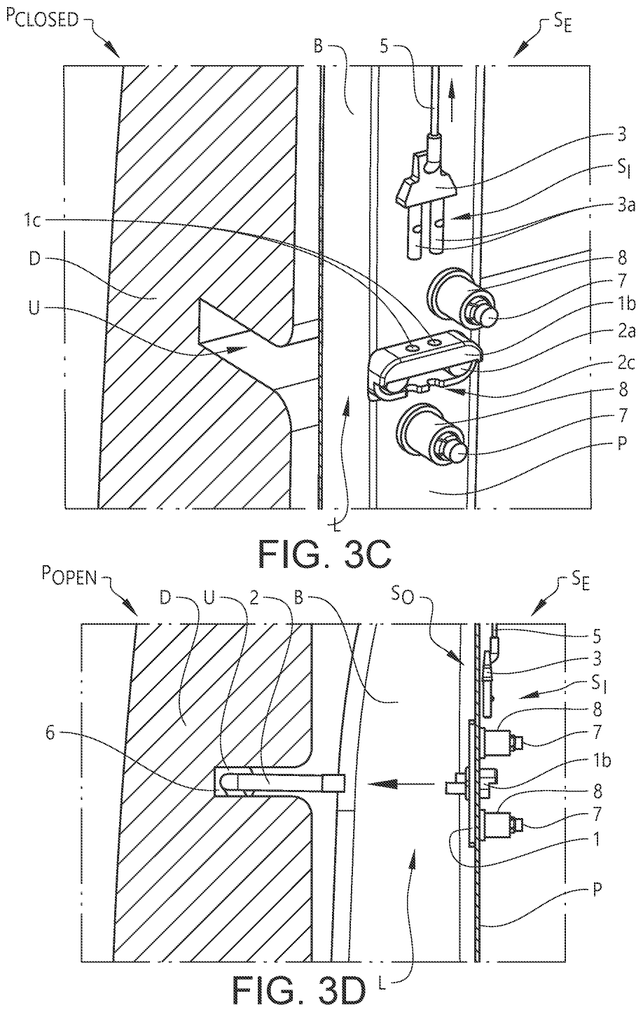

The vehicle door lock L is arranged in connection to the vehicle door D and a door opening O of the vehicle V. The vehicle door lock L comprises a locking unit U arranged in the vehicle door D and a cooperating striker 2 attached to a structural part P of the vehicle body structure B. The striker 2 may have any suitable shape, extension or configuration for cooperation with the locking unit U, such as for example the illustrated traditional loop-like or U-like configuration with two connected shafts. The locking unit U is thus cooperating with the striker 2 for locking the vehicle door D to the vehicle body structure B and for unlocking the vehicle door D from the vehicle body structure B, as exemplified in FIGS. 3A-3B. In FIGS. 1 and 3A, the vehicle door D is shown in open door positions P_{OPEN} and the locking unit U is in the open door positions P_{OPEN} disengaged from the striker 2, allowing the vehicle door D to being displaced for giving access to an interior compartment C of the vehicle V. In FIG. 3B, the vehicle door D is shown in the closed door position P_{CLOSED}, and the locking unit U is in the closed door position P_{CLOSED} engaging the striker 2, preventing the vehicle door D from being displaced to an open door position P_{OPEN}. The locking unit U of the vehicle door D is suitably provided with a locking member 6, such as a latch mechanism or similar arrangement, for engaging and disengaging the striker 2. The locking member 6 is suitably actuated via a door handle in a conventional manner for opening the vehicle door D and disengaging the locking member 6 from the striker 2. When closing the vehicle door D, the locking member 6 is configured for engaging the striker 2 to hold the vehicle door D in the closed door position P_{CLOSED}. More specifically, an outer end 2b of the striker 2 is configured for interacting with the locking unit U of the vehicle door D for releasably connecting the vehicle door D to the vehicle body structure B.

The redundancy system S is providing additional safety to the vehicle door lock L if the vehicle doors D is not possible to open, such as for example in case of vehicle power outage in workshop operations, vehicle battery drainage, or deformation of vehicle components in a vehicle impact event. The redundancy system S is enabling opening of a vehicle door D in such situations.

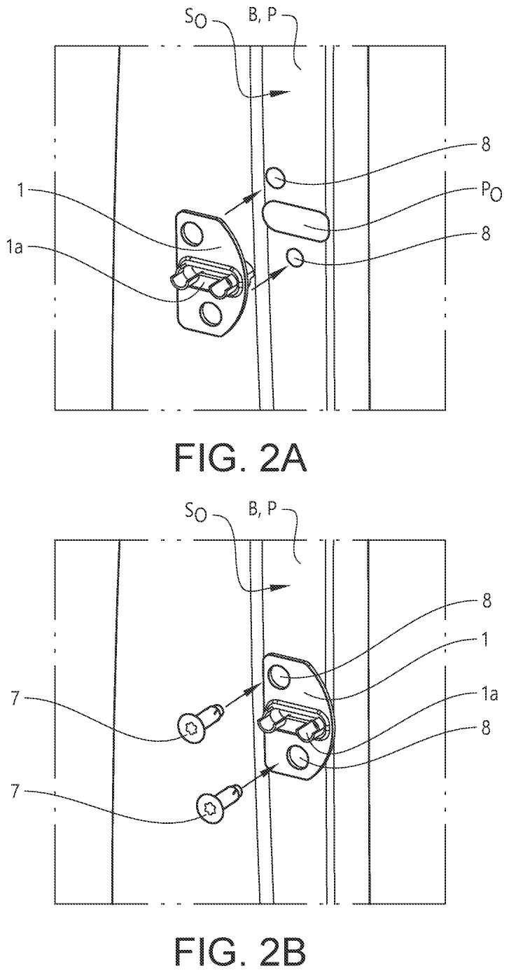

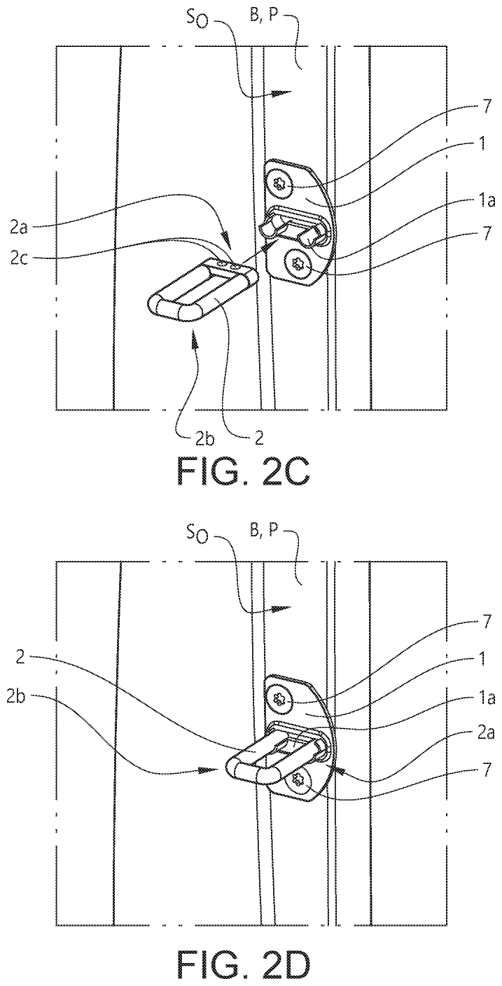

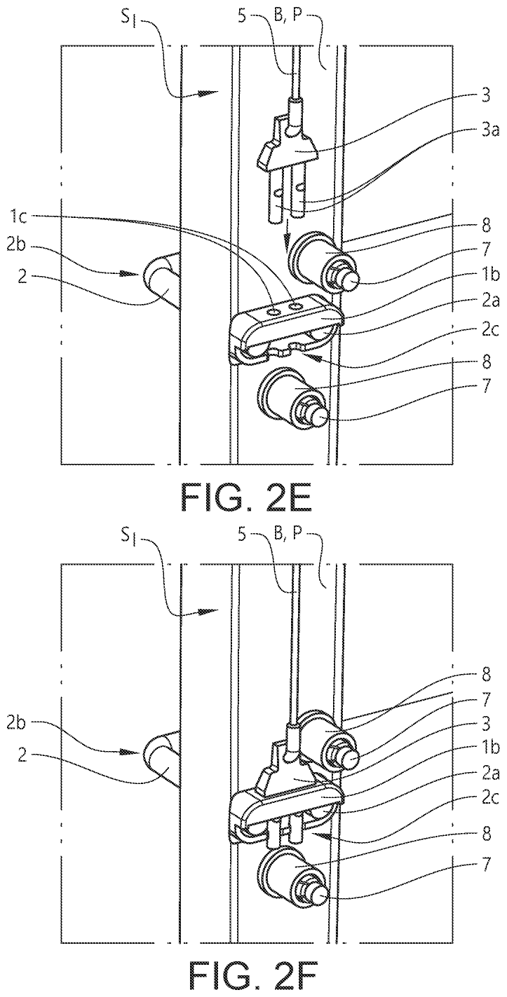

As illustrated in FIGS. 2A-2F and 3A-3D, the redundancy system S comprises a body 1 attached to the vehicle body structure B of a vehicle V and the striker 2. The striker 2 is releasably connected to the body 1, as will be further described below. The body 1 is attached to the structural part P of the vehicle body structure B, and the body 1 may have a plate-like configuration as illustrated or any other suitable configuration or shape. The structural part P is a part or section of the vehicle body structure B arranged in connection to the door opening O, suitable for positioning of the striker 2 and the body 1. The structural part P may for example be a beam structure or a reinforced sheet metal structure to which the body 1 is attached, as schematically shown in FIGS. 2A-2B. The structural part P of the vehicle body structure B may for example be a wall section arranged in connection to an A-pillar, B-pillar, C-pillar, or a D-pillar, of the vehicle body structure B, depending on the vehicle door construction. In the embodiment illustrated in FIG. 1, the structural part P is a wall section arranged in connection to an A-pillar P_{A} of the vehicle body structure B.

The body 1 may suitably be attached to the structural part P with one or more fastening elements 7, such as for example screws, bolts, rivets or other suitable fasteners. The structural part P may be provided with fastening openings 8, as indicated in FIG. 2A, as for example threaded openings or passages for receiving the fastening elements 7 in order to establish a firm attachment of the body 1 to the structural part P. As shown in the figures, the body 1 is attached to an outer side S_{O} of the structural part P with two fastening elements, for a suitable positioning relative to the locking unit U. However, any suitable number of fastening elements 7 may be used for attaching the body 1 to the structural part P.

The body 1 comprises a passage 1a for receiving an inner end 2a of the striker 2, as shown in for example FIG. 2C. The passage 1a is suitably designed with a shape that is corresponding to the shape of the inner end 2a for a snug positioning of the striker 2 to the body 1 with minimized play. To connect the striker 2 to the body 1, the inner end 2a of the striker 2 is pushed towards and into the passage 1a of the body 1, as indicated with the arrow in FIG. 2C. When the striker 2 is inserted into the body 1, as shown in FIG. 2D, the striker 2 is partly extending outwards from the structural part P for engagement of the outer end 2b with the locking unit U of the vehicle door D.

The structural part P of the vehicle body structure B comprises an opening P_{O}, as shown in FIG. 2A. The opening P_{O} in the structural part P_{O} is configured for receiving a part of the body 1, as well as the inner end 2a of the striker 2 when attached to the body 1. The opening P_{O} may have any suitable shape and be arranged as a hole or passage in the structural part P_{O}, and the opening P_{O} is extending through the structural part P from the outer side S_{O} to an inner side S_{I}. The body 1 comprises an inner part 1b that is arranged on the inner side S1 of the structural part P, as shown in for example FIG. 2E. The inner part 1b is arranged in connection to the passage 1a of the body 1, and the inner part 1b is extending through the opening P_{O}. The inner part 1a is configured for holding and positioning the inner end 2a of the striker 2, and may have a shape corresponding to the inner end 2a. As further understood from FIG. 2E, the inner end 2a of the striker 2 is when connected to the body 1 extending into the passage 1a and inner part 1b of the body 1. The inner end 2a is extending through the structural part P of the vehicle body structure B via the opening P_{O}, from the outer side S_{O} of the structural part P to the inner side S1 of the structural part P. With this arrangement, the inner end 2a is extending through the opening P_{O} when connected to the body 1, at least partly positioning the inner end 2a on the inner side S1 of the structural part P. As shown in for example FIG. 2D, the outer end 2b of the striker 2 is arranged on the outer side S_{O} of the structural part P when the striker 2 is connected to the body 1.

The redundancy system S further comprises a connection member 3, as shown in FIGS. 2E-2F. The connection member 3 is arranged on the inner side S1 of the structural part P for releasably holding the striker 2 in a locked position relative to the body 1. The connection member 3 is connected to the striker 2 in a normal operating state S_{NO} of the redundancy system S and the vehicle V, where the vehicle door D is opened through normal operation of a door opening mechanism, such as for example by operating a door handle. When the striker 2 is connected to the body 1, the inner end 2a of the striker 2 is extending into the passage 1a and inner part 1b of the body 1. The inner end 2a is in this way extending through the structural part P of the vehicle body structure B via the opening P_{O} to the inner side S_{I} of the structural part P. The connection part 2c is thus arranged on the inner side S_{I} of the structural part P when connected to the body 1. The connection member 3 is configured for being releasably connected to a connection part 2c of the inner end 2a. The connection part 2c may be arranged as a surface or surfaces that are engaging the connection member 3 when the connection member is connected to the connection part 2c of the striker 2. In the illustrated embodiment, the connection part 2c is arranged as two channel-like passages that are extending through the inner end 2a of the striker 2. The passages forming the connection part 2c are arranged for receiving a part of the connection member 3, as will be further described below. The connection member 3 is preventing removal of the striker 2 from the body 1. When the connection member 3 is engaging the striker 2, the striker 2 is being prevented from being pulled out from the body 1.

As illustrated in FIG. 2E, the inner part 1b of the body 1 comprises a receiving opening 1c. In the illustrated embodiment, the receiving opening 1c is arranged as two passages that are extending through the inner part 1b. The passages are arranged for receiving a part of the connection member 3. The connection member 3 of the illustrated embodiment comprises two protruding elements 3a that are configured for being positioned into the passages of the receiving opening 1c, when the connection member 3 is engaging the connection part 2c of the striker 2. The protruding elements 3a are further configured for engaging the passages forming the connection part 2c of the striker 2 for a robust connection of the striker 2 to the body 1 through the engagement from the connection member 3. When the striker 2 is inserted into the body 1, the passages of the receiving opening 1c and the passages forming the connection part 2c are aligned and configured to receive the protruding elements 3a of the connection member 3. Thus, the connection member 3 is extending through the passages of the receiving opening 1c and further into the passages forming the connection part 2c when the connection member 3 is connected to the connection part 2c. Once the striker 2 has been inserted into the body 1, as described above and illustrated in FIG. 2D, the protruding elements 3a is first inserted into the passages of the receiving opening 1c. In the embodiment illustrated in FIG. 2E, the connection member 3 with the protruding elements 3a are pushed in a downwards direction as indicated with the arrow. Upon further movement, the protruding elements 3a are extending through the passages of the receiving opening 1c and further into the passages forming the connection part 2c, as shown in FIG. 2f for a firm locking connection of the striker to the body. The interaction between the protruding elements 3a and the respective passages are preventing the striker from being released from the body 1.

The connection member 3 may be releasably connected to the connection part 2c through snap-action for a secure connection. The protruding elements 3a may be provided with snap fasteners or similar devices that are interacting with the connection part 2c, or alternatively the connection part 2c may be provided with snap fasteners or similar devices that are interacting with the protruding elements 3a. The snap fasteners may be arranged as spring loaded ball elements that are interacting with recesses. Alternatively, the protruding elements 3a may be arranged as spring-like elements for a secure connection to the connection part 2c.

In the illustrated embodiment, the redundancy system S is arranged with a connection member 3 with two protruding elements 3a, a receiving opening 1c arranged as two passages extending through the inner part 1b of the body 1, and two passages forming the connection part 2c of the striker 2. It should however be understood that the connection member 3, the receiving opening 1c, and the connection part 2c, may have any suitable configuration depending on the design of the system. The number of protruding elements and passages may be different from the illustrated embodiment. Further, the receiving opening 1c may be omitted if desired, as long as the connection member 3 is preventing the striker 2 from being pulled out from the body 1 when the connection member 3 is engaging the striker 2.

The connection member 3 is connected to a releasing mechanism 4, as shown in FIG. 1. The releasing mechanism 4 is used for actuating the redundancy system S in an emergency state S_{E} of the vehicle V. An emergency state S_{E} of the vehicle V in this context is any state where the vehicle doors D are prevented from being opened through normal operation of a door opening mechanism, such as pulling a door handle of the vehicle door D. An emergency state S_{E} of the vehicle V may for example appear in case of vehicle power outage in workshop operations, vehicle battery drainage, or deformation of the vehicle or vehicle components in a vehicle impact event.

The releasing mechanism 4 may for example be arranged as a manually operated lever, where the lever suitably is connected to the vehicle body structure B for simple operation. The releasing mechanism 4 is connected to the connection member 3 via a wire 5, as understood from FIGS. 3A-3D. The wire 5 is thus extending from the releasing mechanism 4 to the connection member 3. The wire 5 may for example be arranged as a Bowden cable connecting the releasing mechanism 4 and the connection member 3. The releasing mechanism 4 is upon activation configured for releasing the connection member 3 from the connection part 2c through action from the wire 5. If arranged as a lever, the releasing mechanism 4 can be manually pulled by a user of the vehicle or any other person for exerting a pulling action on the wire 5. The actuation of a lever as the releasing mechanism 4 is schematically indicated with an arrow in FIG. 1, where the lever is raised from a flat position aligned with the vehicle body structure B to a raised position as shown in dotted lines. Upon activation of the releasing mechanism 4, the wire 5 is configured for releasing the connection member 3 from the connection part 2c. The releasing mechanism 4 may comprise a lock or other protective device for preventing unauthorized use.

The releasing mechanism 4 could have other configurations that the one described above, and may for example instead be arranged as a manually operated pulling mechanism, a manually operated twist actuator, or other suitable manual or electric actuator mechanisms. The releasing mechanism 4 may be arranged in any position on the vehicle V, where the releasing mechanism 4 suitably is accessible from outside the vehicle. It is also possible to connect the wire 5 to an additional releasing mechanism arranged inside the vehicle V for increased safety for vehicle occupants in for example vehicle impact events.

As described above, in the normal operating state S_{NO} the connection member 3 is connected to the connection part 2c for connecting the striker 2 to the body 1. Upon activation in the emergency state S_{E}, the connection member 3 is configured for being released from the connection part 2c. When the connection member 3 is released from the connection part 2c, the striker 2 can be removed from the body 1, as will be described in connection to FIGS. 3A-3D.

In FIGS. 3A-3B, the normal operating state S_{NO} is schematically illustrated, and in this state, the connection member 3 is connected to the striker 2, preventing the striker 2 from being released from the body 1. In FIG. 3A, the vehicle door is arranged in the open door position P_{OPEN}, and in the open door position P_{OPEN} the locking unit U with the locking member 6 is disengaged from the striker 2, allowing displacement of the vehicle door D for giving access to the interior compartment C. It should be understood that the open door position P_{OPEN} is any position of the vehicle door D when moved from the closed door position P_{CLOSED}. In FIG. 3B, the vehicle door D is shown in the closed door position P_{CLOSED}, and the locking member 6 of the locking unit U is in the closed door position P_{CLOSED} engaging the striker 2, preventing the vehicle door D from being displaced to the open door position P_{OPEN}. In the normal operating state S_{NO}, the striker 2 is connected to the body 1 and the locking unit U may for example be handled in a traditional way through normal operation of a door opening mechanism and door movements for disconnecting and connecting the locking member 6 to the striker 2.

In FIGS. 3C-3D, the emergency state S_{E} is schematically illustrated, and in this state, the connection member 3 is removed from the striker 2, allowing the striker 2 from being released from the body 1. If it is determined that the vehicle door D cannot be opened through normal operation of the vehicle door opening mechanism, the releasing mechanism 4 can instead be operated for opening the vehicle door D. By actuating the releasing mechanism 4, the wire 5 and the connection member 3 are being pulled in a direction away from the inner end 2a of the striker and the inner part 1b of the body 1, from the position shown in FIG. 3B to the position in FIG. 3C, as indicated with an arrow in FIG. 3C. Once the connection member 3 is removed, the striker 2 is free to move relative to the body 1, and when forcing the vehicle door to an open door position P_{OPEN} the striker will move with the locking unit U through the engagement with the locking member 6, as shown in FIG. 3D and indicated with the arrow in FIG. 3D. The striker 2 is thus being pulled out from the body through the movement of the vehicle door D when the striker 2 is engaged by the locking member 6. In this way, the vehicle door D can be opened even in case of for example vehicle power outage in workshop operations, vehicle battery drainage, or deformation of vehicle components in a vehicle impact event, where normal opening of the vehicle door D is not possible.

In the emergency state S_{E}, the redundancy system S is thus operated through the following actions: releasing the connection member 3 from the connection part 2c upon activation, and removing the striker 2 from the body 1 when the connection member 3 is released from the connection part 2c. The connection member 3 is connected to the releasing mechanism 4 via the wire 5, and the connection member 3 is released from the connection part 2c through action from the wire 5 upon activation of the releasing mechanism 4 in the emergency state S_{E}.

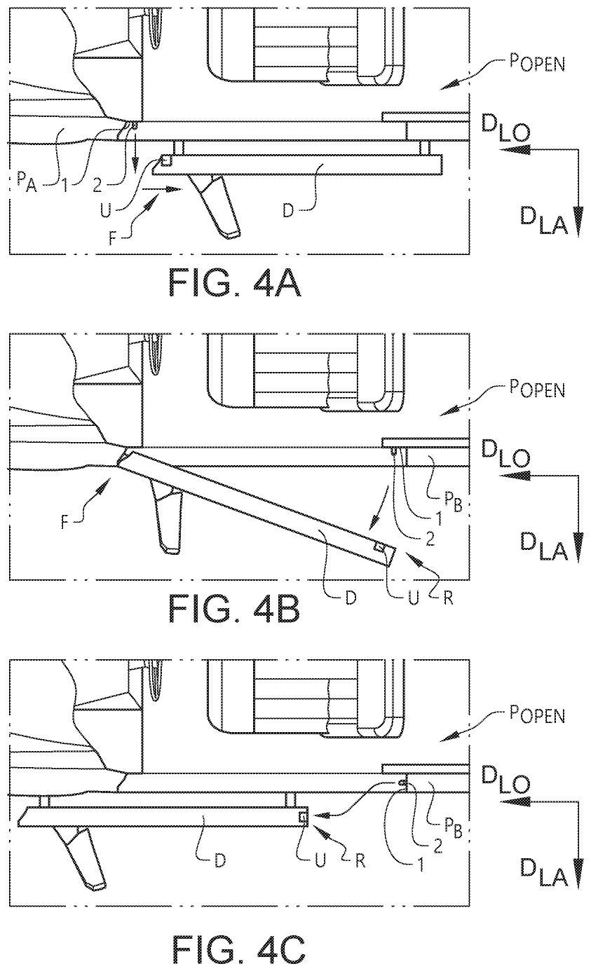

In FIGS. 4A-4C, the positioning of the striker 2 to the vehicle body structure B of the vehicle V is schematically illustrated for different vehicle door types. The vehicle door construction illustrated in FIG. 1 is shown in a view from above in FIG. 4A, where the vehicle door D is first displaced in a lateral direction D_{LA} outwards and thereafter displaced in a longitudinal direction D_{LO} when moving the vehicle door D to an open door position P_{OPEN}, as indicated with the arrows. In this embodiment, the locking unit U is arranged in a front end F of the vehicle door D. With this door opening movement, the striker 2 is suitably extending from the body 1 in the lateral direction D_{LA}, or essentially in the lateral direction D_{LA}, as indicated in FIG. 4A, allowing the striker 2 to be removed from the body 1 in an emergency state.

In FIG. 4b, an alternative vehicle door construction is schematically illustrated. In this embodiment, the vehicle door D is arranged as a traditional swinging door with hinges arranged in a front end F of the vehicle door D. The vehicle door D is displaced laterally outwards from the vehicle body structure B when moving the vehicle door D to an open door position P_{OPEN}. In this embodiment, the locking unit U is arranged in a rear end R of the vehicle door D. With this door opening movement, the striker 2 is suitably extending from the body 1 in a lateral direction D_{LA}, or essentially in the lateral direction D_{LA}, as indicated in FIG. 4b, allowing the striker 2 to be removed from the body 1 in an emergency state.

In FIG. 4C, a further alternative vehicle door construction is schematically illustrated. In this embodiment, the vehicle door D is arranged as a sliding door. The vehicle door D is mainly displaced in a longitudinal direction D_{LO} as indicated with the arrow when moving the vehicle door D to an open door position P_{OPEN}. In this embodiment, the locking unit U is arranged in a rear end R of the vehicle door D. With this door opening movement, the striker 2 is suitably extending from the body 1 in the longitudinal direction D_{LO}, or essentially in the longitudinal direction D_{LO}, as indicated in FIG. 4C, allowing the striker 2 to be removed from the body 1 in an emergency state.

As described above, the structural part P of the vehicle body structure B may for example be a wall section arranged in connection to an A-pillar, B-pillar, C-pillar, or a D-pillar, of the vehicle body structure B, depending on the vehicle door construction. In the embodiment illustrated in FIGS. 1 and 4A, the structural part P is a wall section arranged in connection to an A-pillar P_{A} of the vehicle body structure B. In the embodiments illustrated in FIGS. 4b-c, the structural part P is a wall section arranged in connection to a B-pillar P_{B} of the vehicle body structure B. In an alternative non-illustrated embodiment, the structural part P may be a wall section arranged in connection to a C-pillar and the vehicle door D is a rear side door. In a further alternative non-illustrated embodiment, the structural part P may be a wall section arranged in connection to a D-pillar and the vehicle door D is a rear vehicle door, such as for example a cargo compartment door. It should be understood that the structural part P could be any suitable section of the vehicle body structure B for attachment of the body 1 in connection to a vehicle door D.

When the striker 2 has been removed from the body 1, it may be reinserted again, as described above in connection to FIGS. 2C-2F. The vehicle body structure 2 is suitably provided with an opening or similar arrangement for easy access to the inner side S_{I}.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Body
1a: Passage
1b: Inner part
1c: Receiving opening
2: Striker
2a: Inner end
2b: Outer end
2c: Connection part
3: Connection member
3a: Protruding elements
4: Releasing mechanism
5: Wire
6: Locking member
7: Fastening element
8: Fastening opening
B: Vehicle body structure
D: Vehicle door
D_{LA}: Lateral direction
D_{LO}: Longitudinal direction
F: Front end
L: Vehicle door lock
O: Door opening
P: Structural part
P_{A}: A-pillar
P_{B}: B-pillar
P_{O}: Opening
P_{CLOSED}: Closed door position
P_{OPEN}: Open door position
R: Rear end
S: Redundancy system
S_{I}: Inner side
S_{O}: Outer side
V: Vehicle
U: Locking unit

What is claimed is:

1. A vehicle door lock redundancy system comprising a body attached to a vehicle body structure of a vehicle and a striker releasably connected to the body, wherein an outer end of the striker is configured for interacting with a locking unit of a vehicle door for releasably connecting the vehicle door to the vehicle body structure, wherein the body comprises a passage for receiving an inner end of the striker,
wherein the inner end of the striker is extending through a structural part of the vehicle body structure from an outer side of the structural part to an inner side of the structural part when connected to the body.

2. The vehicle door lock according to claim 1, wherein the body is attached to the outer side of the structural part.

3. The vehicle door lock according to claim 1, wherein the outer end is arranged on the outer side of the structural part when connected to the body.

4. The vehicle door lock according to claim 1, wherein the structural part of the vehicle body structure comprises an opening, wherein the inner end is extending through the opening when connected to the body, at least partly positioning the inner end on the inner side of the structural part.

5. The vehicle door lock according to claim 1, wherein the redundancy system further comprises a connection member configured for being releasably connected to a connection part of the inner end.

6. The vehicle door lock according to claim 5, wherein the body comprises an inner part arranged on the inner side of the structural part, wherein the inner part comprises a receiving opening, wherein the connection member is extending through the receiving opening and into the connection part when the connection member is connected to the connection part.

7. The vehicle door lock according to claim 5, wherein the connection member further is connected to a releasing mechanism, wherein the releasing mechanism upon activation is configured for releasing the connection member from the connection part.

8. The vehicle door lock according to claim 7, wherein the releasing mechanism is connected to the connection member via a wire, wherein the wire is configured for releasing the connection member from the connection part upon activation of the releasing mechanism.

9. The vehicle door lock according to claim 7, wherein the releasing mechanism is arranged as a lever connected to the vehicle body structure.

10. The vehicle door lock according to claim 5, wherein the connection member is arranged on the inner side of the structural part, wherein the connection part is arranged on the inner side of the structural part when connected to the body.

11. The vehicle door lock according to claim 5, wherein the connection member is configured for being releasably connected to the connection part through snap-action.

12. The vehicle door lock according to claim 5, wherein the connection member in a normal operating state is connected to the connection part for connecting the striker to the body, wherein upon activation in an emergency state the connection member is configured for being released from the connection part, wherein when the connection member is released from the connection part the striker can be removed from the body.

13. The vehicle door lock according to claim 1, wherein the structural part of the vehicle body structure is a wall section arranged in connection to an A-pillar, B-pillar, C-pillar, or a D-pillar, of the vehicle body structure.

14. A vehicle comprising the vehicle door lock according to claim 1.

15. A method for operating a vehicle door lock having a body attached to a vehicle body structure of a vehicle and a striker releasably connected to the body, wherein an outer end of the striker is configured for interacting with a locking unit of a vehicle door for releasably connecting the vehicle door to the vehicle body structure, wherein the body comprises a passage for receiving an inner end of the striker, wherein the inner end of the striker is extending through a structural part of the vehicle body structure from an outer side of the structural part to an inner side of the structural part when connected to the body, wherein a connection member is releasably connected to a connection part of the inner end in a normal operating state, wherein the method comprises the steps:
releasing the connection member from the connection part upon activation in an emergency state and removing the striker from the body when the connection member is released from the connection part.

16. The method according to claim 15, wherein the connection member is connected to a releasing mechanism via a wire, wherein the method comprises the step: releasing the connection member from the connection part through action from the wire upon activation of the releasing mechanism in the emergency state.
